(19) United States
(12) Patent Application Publication
(10) Pub. No.: US 2007/0094306 A1
(43) Pub. Date: Apr. 26, 2007

(54) Method and model for enterprise system development and execution

(76) Inventor: Nikolaos G. Kyriazakos, Athens (GR)

Correspondence Address: JEFFREY F. BIRKEL, 2717 BLACK OAK DRIVE, PEKIN, IL, 61554, US

(21) Appl. No.: 11/258,327

(22) Filed: Oct. 26, 2005

(51) Int. Cl. G06F 17/00

(52) U.S. Cl. 707/104.1

(57) ABSTRACT

The method and model for enterprise system development is a software computing system embodied in a method and system that provides for user inputs from a GUI, and specifies a plurality of functions related to a plurality of business entities. Business requirements of the enterprise are defined by establishing relationships among the plurality of business entities. The relationships among the plurality of business entities are interpreted. A plurality of actions is applied to the plurality of functions based on the interpretation of the business entity relationships, creating a plurality of logical entities. Activity rules related to the plurality of logical entities are specified. The plurality of functions is executed in a workflow determined by the plurality of activity rules to apply business requirements developed by the system. Global security levels are included to provide control of collaboration over the system in a dynamic and flexible way.

### BACKGROUND OF THE INVENTION

1. Field of the Invention

The present invention relates to a software computing system, and more particularly to a method and model for enterprise system development wherein the method and system manages business processes in data according to requirements input by a user while maintaining very low software code overhead in the required business applications.

2. Description of the Related Art

Business application software has been in the market for at least 30 years. The various applications developed over this time frame have evolved into systems having common characteristics that in one way or the other still fall short of a development platform that meets today's business requirements.

For example, in new application creation related art development platforms usually necessitate a requirements specification defining application behavior, a data model describing objects of the application, and computer code written to implement functions to process, display, print, import and export specific data as defined by the data model.

ERP, i.e., Enterprise Resource Planning, supply chain systems, manufacturing systems, quality control systems, and accounting systems rely heavily on this methodology. Systems developed using the aforementioned methodology generally cover a certain range of functionality with very little overlap.

One common shortcoming of the above-mentioned systems is that each system can be used only inside the range of applications designed specifically for that system. For example, a system designed for accounting cannot do manufacturing because the computer executable code does not provide any business functionality for manufacturing.

Additionally, if a data model was designed for a small company, the same model could not be used for a bigger company because the computer code could not recognize a scaled up data model. Even minute changes in the data model could cause a typical application to fail.

The aforementioned problems have fostered solution attempts bringing about large enterprise systems that have a very large number of applications. However if a user had a requirement to work with more sets of data and additional business logic, the aforementioned applications would not recognize the additional data sets and business logic. Additionally, the increased number of applications in the aforementioned systems has resulted in software configuration management problems wherein any new system release is likely to have numerous code errors, i.e., bugs that must be corrected.

Business rules modification utilizing the aforementioned systems is a tedious task requiring customizations of the computer code. Such customizations incur additional development costs, regression testing costs, and the like.

But the most serious problem is that for any given company application requirements are continuously changing as the business evolves due to competition pressures, thus leading to customizations of the applications. As discussed above, customizations lead to unwanted additional costs. The increased customizations lead to many systems that must be integrated, thus leading to system integration costs in addition to the development and regression testing costs.

Additionally, to customize a computer system in a typical business development environment, consultants with knowledge of customer needs, as well as programmers with knowledge of specific programming languages and computer systems are needed. Generally speaking, the programmers do not understand the needs of the specific customer i.e., customer business requirements, so an additional layer of communication is needed between the consultants and the programmers. As a result, the slightest requirements change or program bug requires the aforementioned layer of communication to be established over and over again, further increasing development costs.

Moreover, these enterprise systems of the related art require a halt of all system applications before an application can be added or changed. The halting of all system applications further increases development and maintenance costs.

Furthermore, application development within an existing enterprise system of the related art is fraught with complicated contractual agreements dealing with intellectual property rights, long training times and other similar obstacles. Frustrated business managers may cancel an upgrade of business logic and information because of the aforementioned obstacles.

Another problem is out-sourcing of programming positions to lower labor cost countries notwithstanding the fact that knowledge, expertise and system requirements remain in the outsourcing country. Therefore, it is clear that it is necessary to design new generations of application systems that will have characteristics to foster revitalization of the enterprise and business software.

Attempts have been made to solve the aforementioned problems, for example, Japanese Patent No. 2002-215,393, published Aug. 2, 2002, discusses a business application constructing method in which code is automatically generated based on a design information database.

Additionally, Japanese Patent No. 11-53,231, published Feb. 26, 1999, discusses combining a business application with a database, apparently in an attempt to address system integration issues.

Moreover, International Patent WO 96/31828, published Oct. 10, 1 996, discloses generating application without code normally associated with a software application. However, code is still generated in the form of a metalanguage embedded in a plurality of system control tables.

Thus, a method and system for enterprise system development solving the aforementioned problems is desired.

### SUMMARY OF THE INVENTION

The method and model for enterprise system development and execution provides for the creation, modification, interpretation, integration and implementation of business processes while configuring business process applications that implement the required business processes in data so as to generate very low software code overhead. Business processes may be generated as specific data structures.

The system has the capability to interpret the specific data structures and generate applications, i.e., methods to implement the business rules enterprise wide. More specifically, a set of relational databases are defined in conjunction with a graphical user interface, (GUI), and rules interpreter to provide the functionality of rules/feature addition, deletion or modification without creating additional software code.

The relationship modeling and relationship interpreting of the present invention allows a user to define the business rules, i.e., business methods, through the application of function definitions and action definitions to the function buttons and action buttons displayed in the GUI. Moreover, all functional elements of a required business process are stored in data needed by that business process. Interpreters operating on the data are provided to generate application functionality.

Thus, two main components of the enterprise system development method and system are: (1) a model of data and the rules with which most of the functionality of an application can be codified in the data; and (2) A Universal Service application providing a data model interpreter which creates an application having the specific functionalities codified in the data model, as specified by the user. Advantageously, the software code of the present invention mainly comprises the data interpretation function. Thus, the size and complexity of the software code of the present invention should not grow in proportion to the number of business applications generated. Additionally, code writers, i.e., the users, need not have expert level application knowledge because the system provides for user inputs in terms of abstract notions, i.e., user inputs to at least one relational database of the data models and rules.

When application developers having specific knowledge of a business application are required, they may limit the scope of the business application development process to the rules of interpretation as provided by the Universal Service application.

Additionally, new enterprise system development may be accomplished merely by initiating a copy function of the data required by the new system, because the present invention is already primarily in the form of data, and not in code. Also, an application under the present invention can be changed by just changing the data that it requires. Moreover, due to the interpretive nature of the business application generation of the present invention, specific business logic is external to the software code and is only activated through the method and system of the present invention. The aforementioned features of the present invention result in an open system having the capability to continuously evolve, and to be easily customized.

The present invention may be comprised of at least one, preferably relational, database having at least one data model, interpretation data and an interpretation application to provide application generation according to requirements input to a GUI by a user. More specifically, the present invention provides for specifying a plurality of functions to be related to a plurality of business entities, defining business requirements of the enterprise by establishing relationships among the plurality of business entities, interpreting the relationships among the plurality of business entities, applying the plurality of actions to the plurality of functions responsive to interpreting the relationships among the plurality of business entities, in order to create inter alia, a plurality of logical entities, specifying a plurality of activity rules to be related to the plurality of logical entities, and then executing the plurality of functions in a workflow determined by the plurality of activity rules so that the requirements are applied to the enterprise with very little software overhead.

These and other features of the present invention will become readily apparent upon further review of the following specification and drawings.

### BRIEF DESCRIPTION OF THE DRAWINGS

FIG. 1 is a block diagram of a network for enterprise system development and execution according to the present invention.

FIG. 2 is a block diagram of a computer suitable for practicing the method and model for enterprise system development and execution according to the present invention.

FIG. 3A shows a VIEW page of the GUI of a model for enterprise system development and execution according to the present invention.

FIG. 3B illustrates an Insert/Edit page of the GUI of FIG. 3A.

FIG. 3C shows a Manage Tasks page of the GUI of FIG. 3A.

FIG. 4 is a block diagram representing global security levels of a model for enterprise system development according to the present invention.

FIG. 5 is a block diagram showing construction of VIEWS from Inter-table relations of tables and fields in the Data Dictionary of the model for enterprise system development according to the present invention.

FIG. 6 is a chart showing the Application Model hierarchy of entities of the model for enterprise system development according to the present invention.

FIG. 7 is a chart showing the User Model hierarchy of entities of the model for enterprise system development according to the present invention.

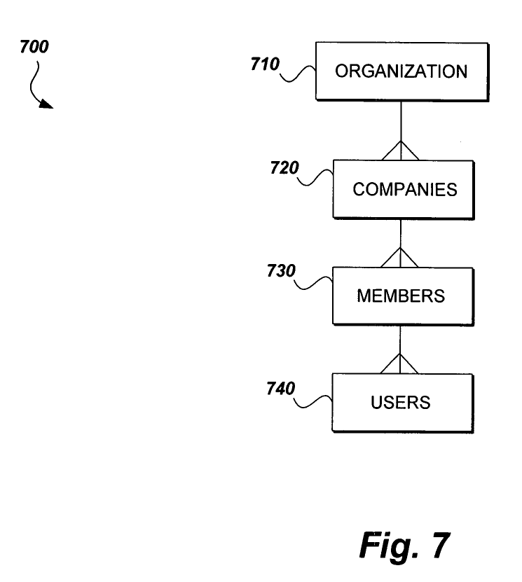

FIG. 8 is a chart showing a summary of Action Button definitions of the model for enterprise system development according to the present invention.

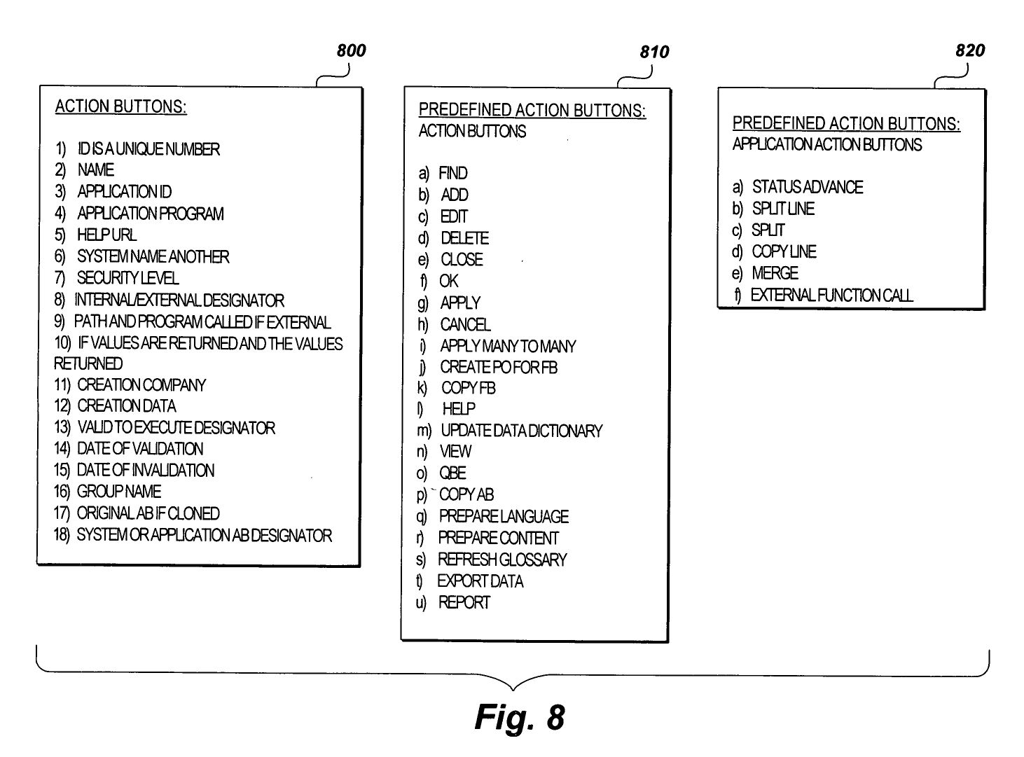

FIG. 9 is a chart showing Function Buttons, Menus, Folders and Processing Options of the model for enterprise system development according to the present invention.

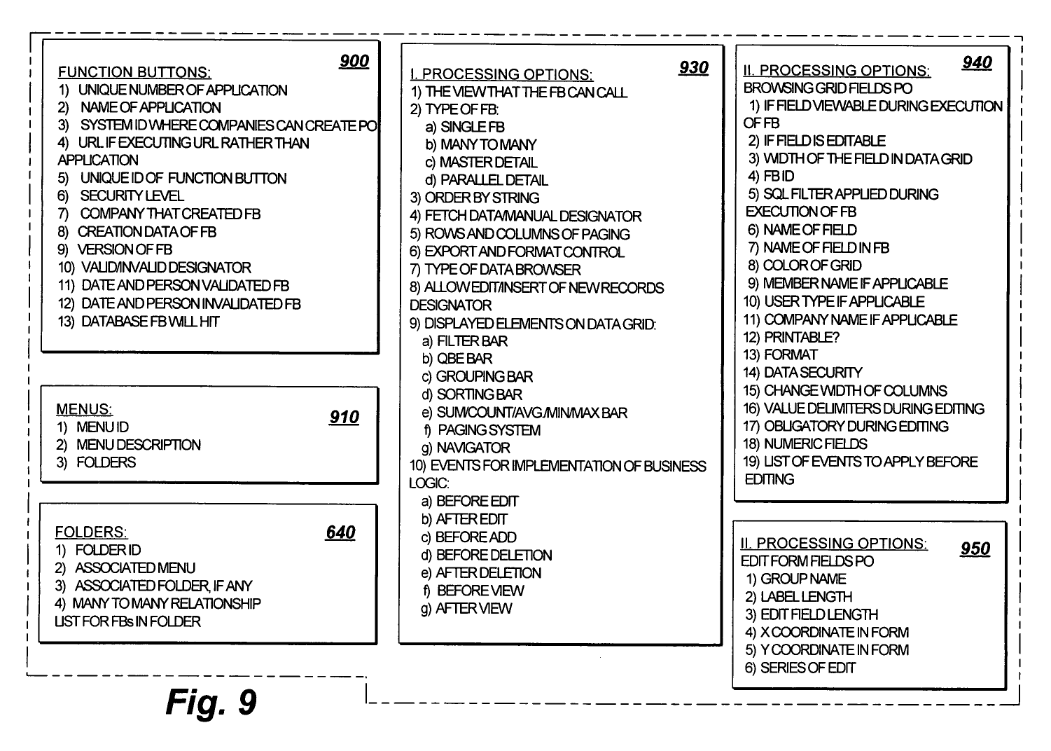

FIG. 10 is a block diagram showing the Universal Service application of the model for enterprise system development according to the present invention.

Similar reference characters denote corresponding features consistently throughout the attached drawings.

### DETAILED DESCRIPTION OF THE PREFERRED EMBODIMENT

The present invention relates to a software computing system, and more particularly to a method and model for enterprise system development wherein the method and model manages business processes in data according to requirements input by a user while at the same time creating very low software code overhead. The method of the present invention, in response to requirements input by a user, is capable of constructing a plurality of business entities, specifying a plurality of actions to be related to a plurality of business entities, defining business requirements of the enterprise by establishing relationships among the plurality of business entities, interpreting the relationships among the plurality of business entities, applying the plurality of actions to a plurality of functions responsive to the interpretation of the business entity relationships, and then executing the business functions in a workflow determined by a specified plurality of activity rules.

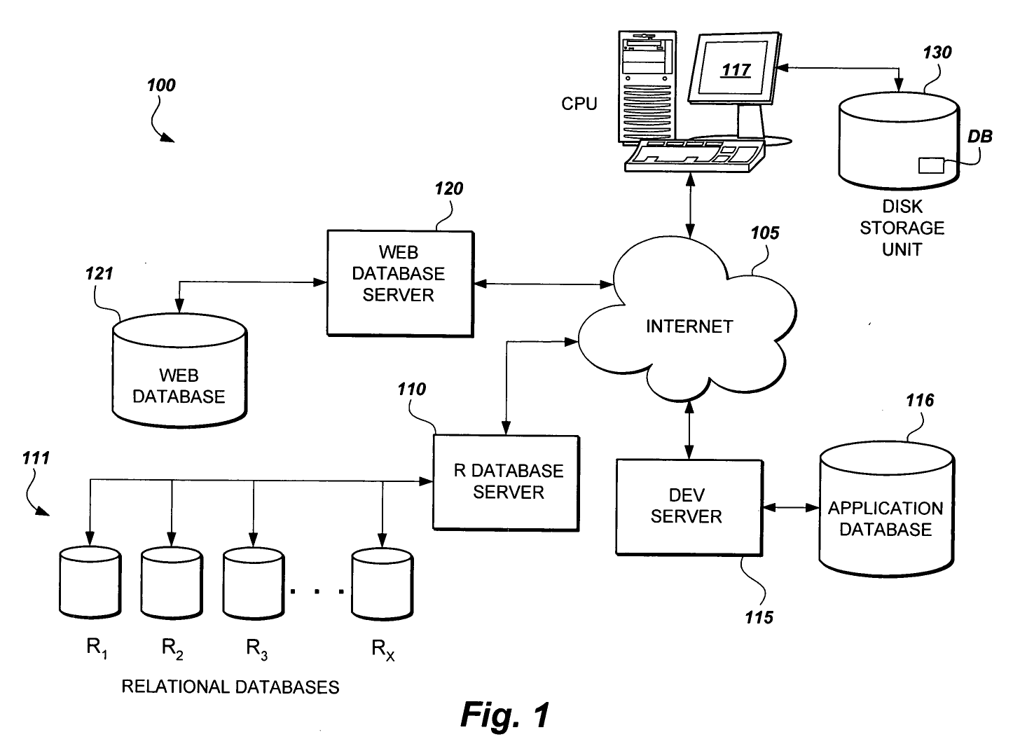

Execution of the business functions according to the workflow provides the present invention with the capability to perform new business functions without adding a proportionately greater amount of software code, i.e., very little software overhead is generated by the aforementioned method of the present invention. As shown in FIG. 1 100, one embodiment of the method and system for enterprise system development includes a minimum of 1 server and 1 client, for operation in conjunction with at least one user. Preferably, processing elements are distributed and may communicate with each other via Internet cloud 105.

Processing elements of the present invention include but are not limited to central processing unit 117 associated with a user and connected to disk storage unit 130 having the capability of storing at least one database, DB, a database server 110 for serving content of relational databases 111, a development server 115 including and application database 116, and a web server 120 including a web database 121.

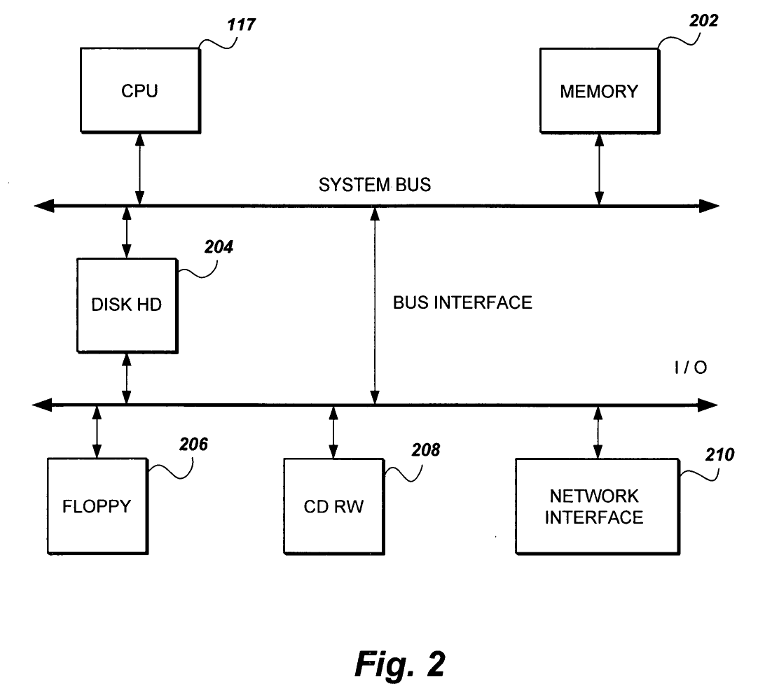

Additionally, FIG. 2 shows a typical user CPU 117 including connection with hard drive 204, memory 202, floppy drive 206, CD RW storage unit 208 and network interface 210 having a configuration capable of supporting system communication within the present invention.

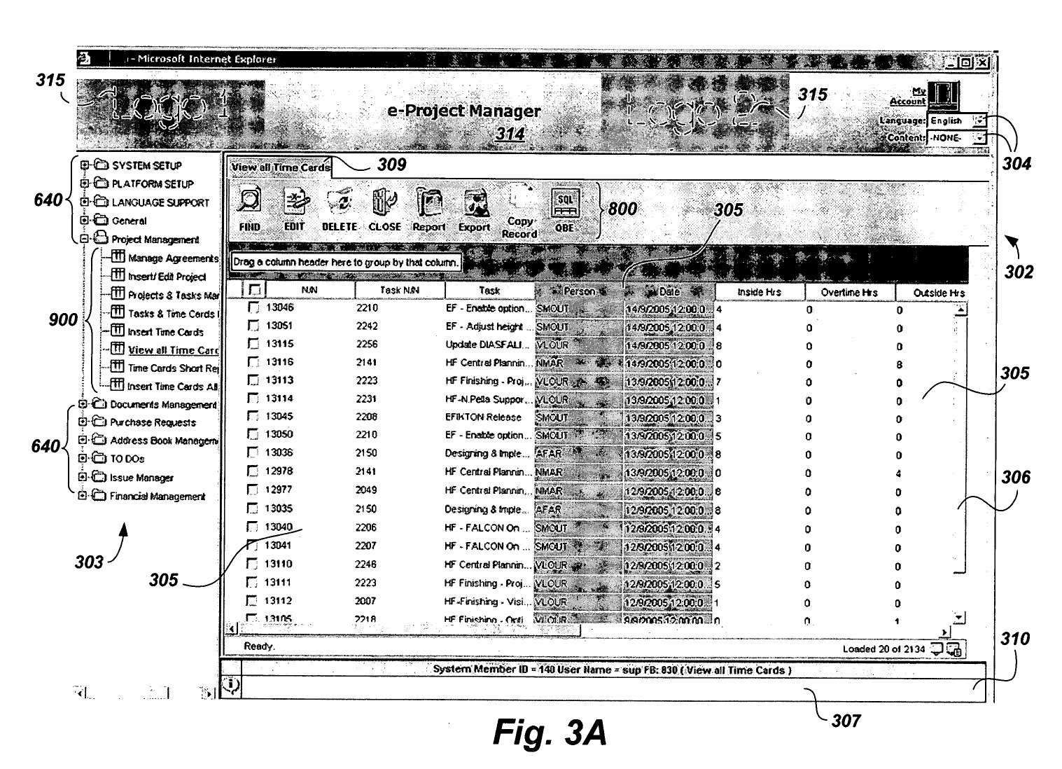

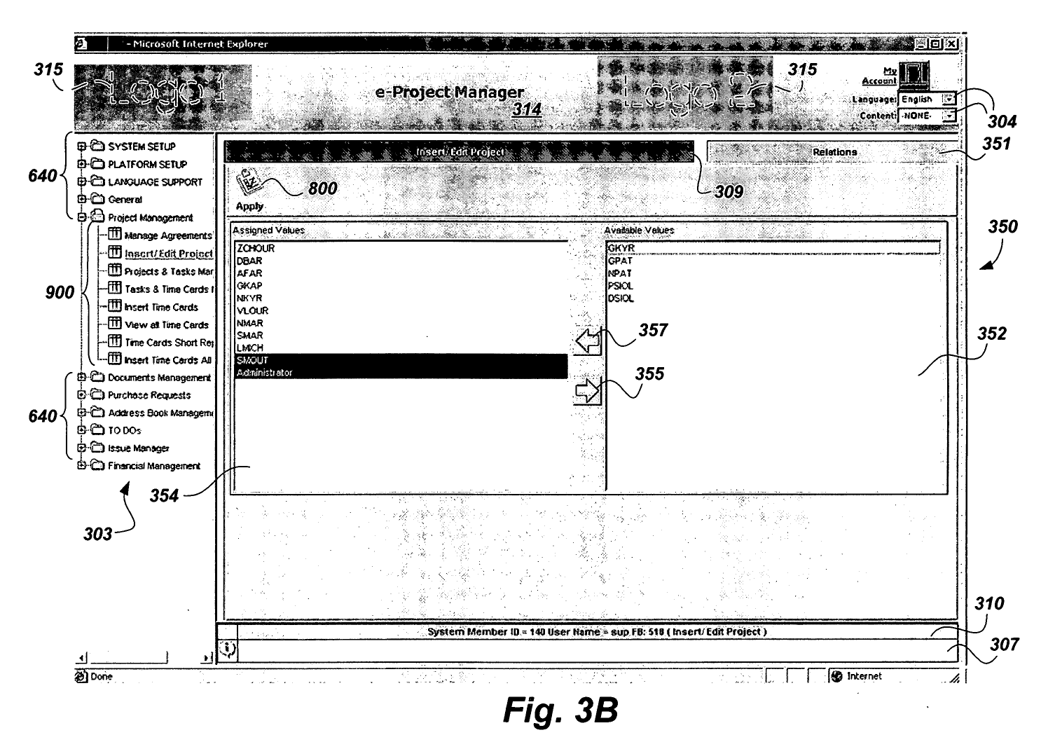

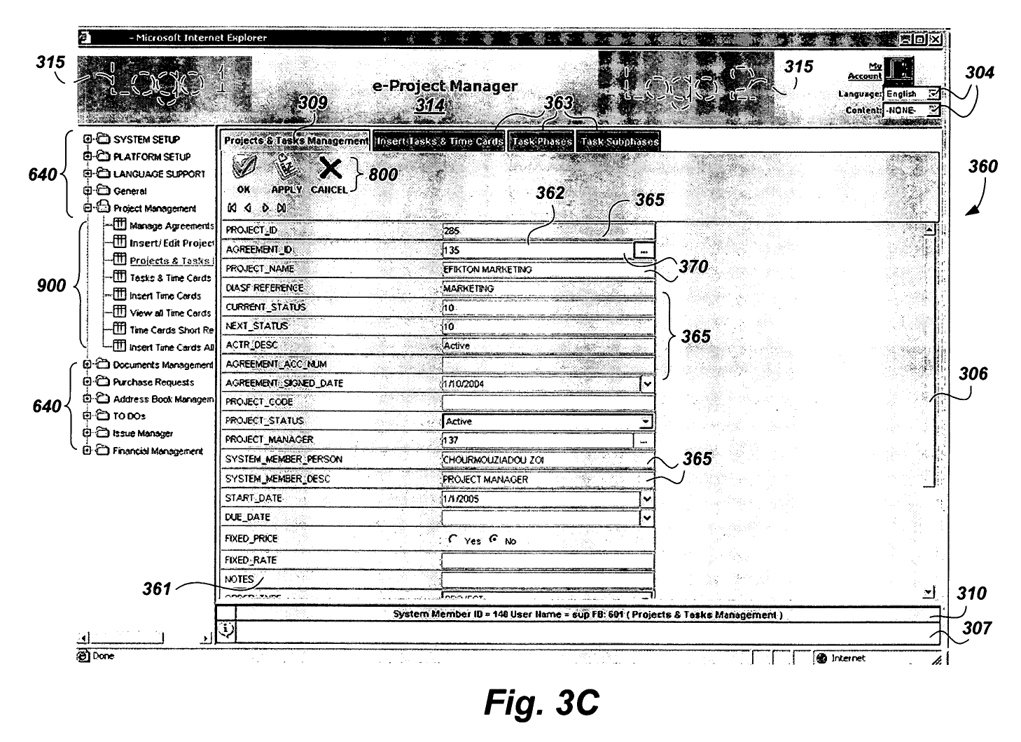

As shown in FIG. 3A, the user has access to the aforementioned processing elements through GUI 302, and may input business requirements to the system by the GUI means provided.

Referring to FIGS. 3A through 3C, it is shown that representative GUI pages 302, 350 and 360 each are comprised of a framework divided into four smaller frames defined as the Navigation Area, i.e., Menu Area 303, the Banner area 314, the Main Working Area, i.e., data grid area 305, Function Button Status bar 310 and the Message Area 307.

As shown, the Menu Area 303 is an area from which all the navigation throughout the present invention is being performed. The Menu Area 303 displays a Tree View in which a plurality of nodes corresponds to Folders 640 or Function Buttons 900. Organization of the nodes is fully hierarchical, thus enabling the existence of the folders 640 under a Root node that contains nodes of a specific similar functionality group. The plurality of nodes corresponding to the Function Buttons 900 may be distributed within the plurality of nodes corresponding to the Folders 640. The Tree View is totally configurable by the user through functionalities provided on an administrator menu.

Furthermore, the Banner Area 314 of GUI pages 302, 350 and 360 comprises at least one company logo 315, customer, copyright information and business application title. Additionally, access to, and language selection for a User Account Management form are provided by a language and content pull down menu 304 of the Banner Area of GUI pages 302, 350 and 360.

The Main Working Area 305 of GUI pages 302, 350 and 360 is a frame within which an application's functionality is displayed. During application use, all Forms of the present invention are loaded in the working area.

The Message Area 307 of GUI pages 302, 350 and 360 displays messages relevant to the functionality of the application, and may provide error messages, warnings, and the like.

Other features of GUI pages, such as GUI 302 include the capability to configure the GUI 302 dynamically, i.e., enlarge a specific working frame by moving the frame areas or use. Additionally, keyboard shortcuts for a context menu may be activated.

The present invention provides data, structures and rules in at least one preferably relational database that can codify most of the functionality of an application. The capability to provide data, structures, and rules permits complete organization of a business based on requirements input by the user while, except for a few special cases, obviating the need to write software code for implementation of the business logic.

The present invention has the capability to modify, delete, or add business requirements by user interaction with the data structure, i.e., relational databases, thereby reducing the need for programmers to modify applications. Thus a typical user of the present invention who is tasked with developing business rules and applications has the role of analyst with expertise in database knowledge, rather than computer programming knowledge. Additionally, users are not constrained geographically because functionalities provided by the present invention may be networked via communication over the World Wide Web. Moreover, the present invention is capable of developing systems such as, for example without limitation, collaborative project management, outsourcing of manufacturing, manufacturing management, product development, product lifecycle, and computerized support for certification programs, and the like. Additionally, the present invention can interact with a multitude of external systems thereby expanding the over-all functionality and available information to the system. The present invention allows secure and organized Internet access to data residing in a multitude of databases. Additionally, the enterprise system development execution method and model of the present invention can be used as an integration platform for a variety of enterprise systems.

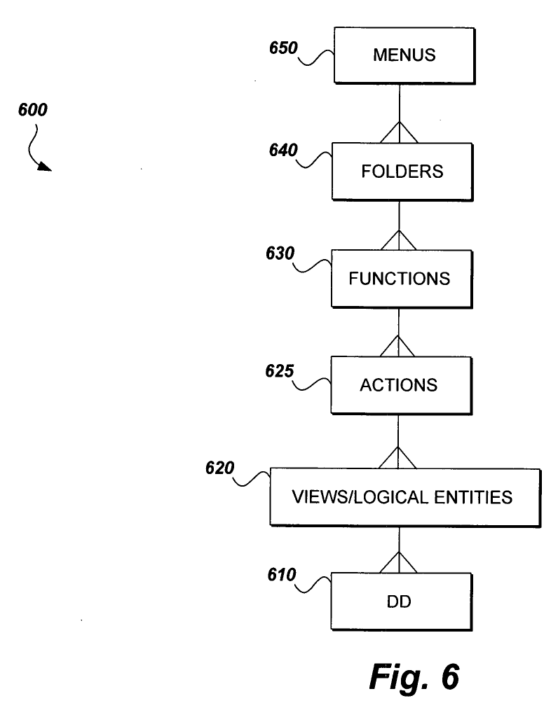

As shown in FIG. 6, the data model is comprised of a hierarchical model of data structures, i.e., application model AM 600. The application model, AM 600, provides data codification of required business applications.

The Application Model, AM 600 is comprised of hierarchies such as, for example, from lowest to highest, the data dictionary DD 610 which contains all information in tables and fields; inter-table relations, such as VIEWS 620, which join fields of different tables into one Logical Entity; ACTIONS, AB 625, which comprise elementary actions; FUNCTIONS, FB 630, which comprise the most elementary level of an application; FOLDERS, FO 640, which contain other folders 640 and FUNCTIONS 630; and MENUS, ME 650, which contain FOLDERS 640. Additionally, one application may be included in many folders 640.

All information used by applications is categorized as INFO OBJECTS. The INFO OBJECTS are organized in tables, one of which is the Data Dictionary 610, a table of primary importance. The Data Dictionary 61 0 includes a Table Dictionary and a Field Dictionary. Each Table Dictionary includes a structure comprising a Unique Number, a Name, a String, a Procedure Name, a Table Declaration field, and a Database field. The present invention provides for the following table definitions as delineated in TABLE 1A

TABLE 1A

| Field Label | Control | Function | Purpose/Use |
|---|---|---|---|
| N/N | NUM (NN PK) | Table Primary Key | Identification of |
| | | that is Next | the Table |
| | | Number, updated | |
| | | automatically | |
| | | when inserting a | |
| | | new row | |
| Table Name | TEXT | User inserted | Name of the |
| (DB) | | text. | Table or the View |
| | | | in the Database |
| Table Name | TEXT | User inserted | Name of the |
| (System) | | text. | Table or the View |
| | | | in the System. |
| | | | (same as in |
| | | | Database) |
| Table Name | TEXT | User inserted text | Name of the |
| (UI) | | | Table or the View |
| | | | in the User |
| | | | Interface (same |
| | | | as on Database) |

The Procedure Name is the name of a procedure that created the specific table being accessed. The Table Declaration field provides a means for declaring whether a table is a data table or an inter-table. The Database field identifies the database that a table resides in. Each table may be stored in a plurality of databases.

The Field Dictionary, i.e. Field Table, is a table that provides all of the individual fields included in each Dictionary Table. Field Table structure includes: a unique number of a field name; a number of the Dictionary Table that belongs; a unique name of the field; information having a database field type, i.e., whether the field is a string, number, date/time, field length, and the like. Moreover, additional field descriptor fields are provided in the Field Table describing field characteristics associated with the scope of translating the data into applications. Field descriptor fields comprise: data indicating whether a field is UOM so that it can be treated with a Units of Measures Mechanism; Foreign Key, FK, having a foreign key table number while showing that the particular field looks in another table; User Defined Code, UDC, and a UDC alias name; Attachment file, for fields describing a name of a file attached to an associated record; multiple attachment files; Universal Resource Locator, URL, is provided if the field must be interpreted as a URL; Multiple URL; hierarchy, provided as a tracing mechanism for splitting record lines; Attributes which accompany an attribute Group and group attribute separator; Content translation, provided to indicate whether content is by language or content is by company; Data Security Level, provides a security level that a user 740 must have before the user 740 is able to view the data; field designators associated with the Workflow mechanism, such as a Current status designator, a Next status designator, a Document Type designator, a Line Type designator, and, a Status Advance Date designator, and the like. Additional designator fields related to a user 740 are provided, e.g.,: a Member Type designator; a Company Type designator; a User type designator; a Last User Update designator; a Create User designator; a Numeric for Split Line designator; a Last Update Date/Time designator; and, a Create Date Time designator.

The aforementioned workflow and user designators are provided for use by a Universal Service 1000 during interpretation to perform functionalities associated with workflow and User Access. Moreover, the software of the present invention has the capability to create database tables from the Data Dictionary 610 and vice versa. When creating a Data Dictionary 610 from the database tables, the supplementary data necessary must be created manually.

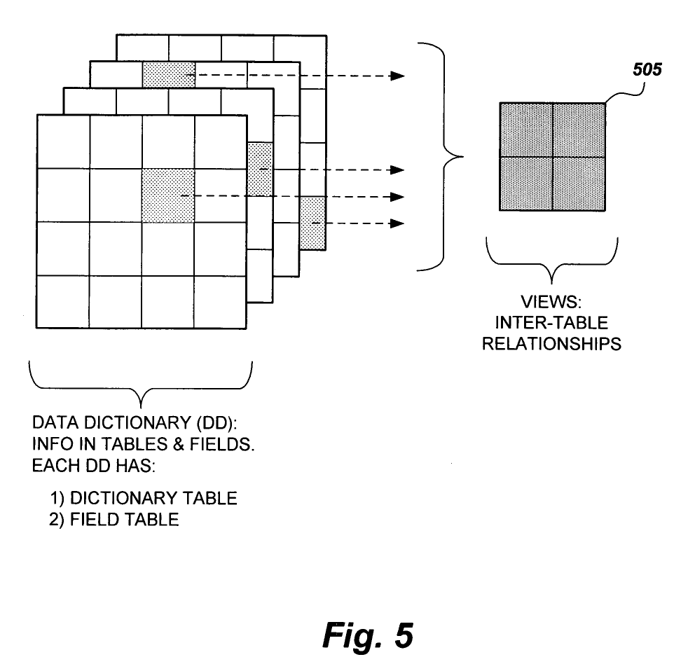

Referring to FIG. 5, note how the present invention provides for table interconnections by allowing Information Entities, i.e., selections of fields from different tables. The selections comprise inter table relations 505 and are provided by using the VIEW 620 creation of the standard data base functionality. The views are comprised of tables in the data dictionary 610 with a characteristic VIEW 620 and a name having the string of a SQL procedure that creates the view. Views may populate a Data Dictionary 610, or the Data Dictionary 610 may create views.

When a view has joined fields of different tables into one logical entity, operations may be performed on the particular Logical Entity that has been created. Any single operation performed on a Logical Entity is an Action 625. An Action 625 can be internal or external to the system. Internal actions are codified in the system, external actions are Actions that can be created outside of the system as external code but can be declared and triggered from inside the system. Within the realm of the GUI 302, Actions 625 are represented by Action Buttons; AB 800. Action Buttons 800 are specific function units that perform simple actions on data that the user handles. External code written for external action buttons is modularized and compact, thus reducing the potential for software errors and lowering software development related maintenance costs.

Actions 625 are described in an Action Button table that includes: a unique number known as an Action Button ID, AB ID; an Action Button Name, AB Name; an AB Application ID that is provided to show which applications can execute the operation. If the Application ID, AB ID, is zero, then all applications can perform the action 625.

The Action Button table also includes an AB Application Program field describing which programs of the application may execute the action. A zero in this field indicates that all application programs may execute the action. Furthermore, Applications and Programs are logical divisions of all functionality of the system, e.g., manufacturing may be an application, and Working Order entry may be a Program. Similarly, Project Management may be an application, while Task Management may be a program.

Further descriptions in the Action Button table include a HELP URL for each Action Button. The HELP URL opens a web page to explain the functionality of the associated Action Button. Additionally, an AB System Name is provided to indicate systems and companies available to perform the designated Action. An AB Security Level is provided to define which User may have access to the action during execution of the action.

An AB internal/external indicator to indicate whether the Action Button 800 is internal or external to the system is provided. If the AB is external to the system, an additional field is provided to indicate the external path and program that must be called. An AB 800 defined to be external to the system is the modality of the present invention that provides for exceptional cases where execution of business logic must be through additional software code rather than the typical method of the present invention which provides for business logic execution through defining data relations by creating new tables or relations between tables or new fields. As shown in FIG. 3A, a section of the GUI provides a data grid area 305 for the presentation of all data. External AB provide for execution of specific functions for a specific grid or specific lines of a grid in the grid section of the GUI.

Additionally, if an AB 800 is supposed to return a value, an AB return value field is populated to indicate what values are to be returned. An AB creation company field is provided to indicate the company that created the action. A Creation Data table entry is provided to populate the entry with data required by the action.

Furthermore, an AB Valid entry is provided to indicate whether an action is valid to be executed, as determined by the system administrator. Table entries associated with the AB Valid entry are a Date of Validation entry and a Date of Invalidation entry. Additionally, a Group Name table entry is provided to indicate the group authorized to execute the action. If an AB has been cloned a table entry associated with the AB is populated to indicate the original AB from which the copy was made. An entry is also included to indicate whether an AB is a system AB or an application AB.

Predefined Action Buttons are provided, in which they are divided into predefined system Action Buttons 810, i.e., Database Action Buttons, and predefined application Action Buttons 820, i.e., Business Action Buttons. The following table indicates the system predefined Action Buttons included in the system.

TABLE 1B
Predefined System AB Definitions

| | |
|---|---|
| FIND | Starts Fetch from the database for a |
| | specific inter-table |
| ADD | Adds a record of a table to the |
| | database |
| EDIT | Edits a record |
| DELETE | Deletes a record |
| CLOSE | Closes an application window |
| OK | Confirms a change |
| APPLY | Applies a change to the database and |
| | returns the result |
| CANCEL | Cancels a change |
| APPLY M2M | Applies a many to many relation table |
| CREATE PO for FB | Specific action to automatically create |
| | parameters of an application |
| COPY FB | Clone a complete application that can |
| | be diversified later |
| HELP | Display the help of a certain |
| | application |
| DD Update | Loads the last data of the Data |
| | Dictionary to an engine of the System |
| TG Update | Updates a Translation Glossary |
| View | Opens a single record for view |
| QBE | Opens a query by example form in an |
| | application |
| COPY AB | Clone an Action Button that can be |
| | diversified later |
| PREPARE LANGUAGE | Prepare the table entries for a new |
| | Language |
| PREPARE CONTENT | By company |
| REFRESH GLOSSARY | Refresh the system engine with the |
| | content of the Glossary |
| EXPORT DATA | Exports data of an Application to |
| | another Application |
| REPORT | Delivers an application report |

TABLE 2
Predefined Application AB Definitions

| | |
|---|---|
| STATUS ADVANCE | Regulates status of a given data |
| | group |
| SPLIT LINE | Splits a record in two with certain |
| | criteria |
| SPLIT NUMERIC | Splits a record in two with |
| | predetermined criteria based on |
| | predetermined numeric fields |
| COPY LINE | Copy a record to a new record |
| MERGE | Merge two or more records into |
| | one with predetermined criteria |
| EXTERNAL FUNCTION CALL | Calls an external program starting |
| | from a selected dataset |

Each AB includes behavioral information during execution, i.e., each AB method is included. An AB may be cloned to create Action Buttons with slightly different behaviors from the original AB.

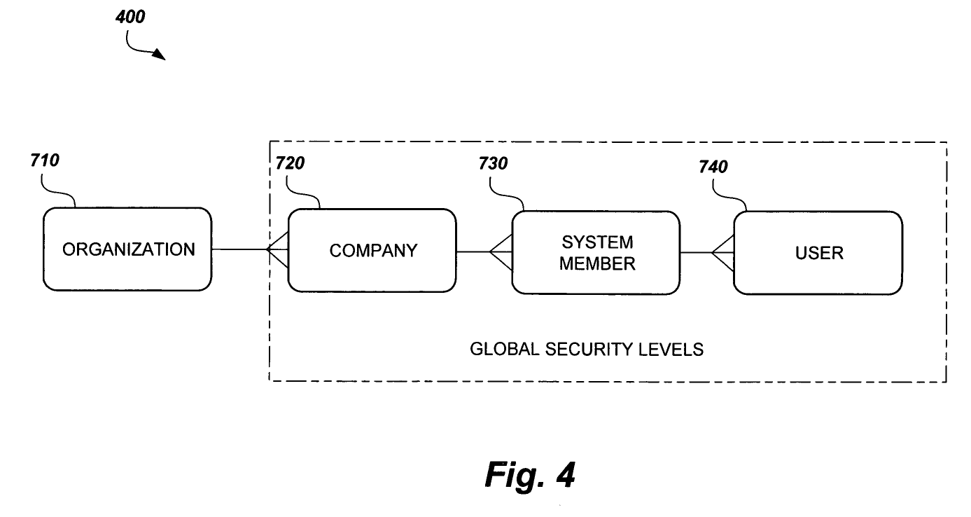

As shown in FIG. 4, a Function Button, FB 900, is the smallest element of an application. Function Buttons 900, being primarily important components of the data model comprise a complete environment where a User 740 can manipulate data and actions. Function Buttons 900 constitute basic functional entities of the present invention, and comprise a predetermined number of business processes. Function Buttons 900 include all data of the elementary operations, and are defined within a Function Button table. To create an application, a user combines up to a plurality of function buttons 900. An FB 900 includes nearly all data codification information that could be required to construct an application desired by the user. The system of the present invention is collaborative in that it allows a plurality of users 740 to process the same block of data related to an FB 900 in different ways, each user being provided with the capability to instantiate a different version of a particular FB 900. A function button 900 includes, but is not necessarily limited to the information as shown below in Table 3.

TABLE 3
Function Button Information

| | |
|---|---|
| Unique number of the Application | |
| Name of the Application | |
| System ID under which different | Processing Options are defined in |
| companies can create Processing | this specification infra. |
| Options (PO) | |
| URL name if FB does not execute an | |
| application but a URL instead | |
| Unique ID of the FB | |
| Security level of the FB, used in | Allows separation of Menus |
| conjunction with the USER Menu | between users |
| range, expressed as a number to | |
| determine whether a user may | |
| execute the FB | |
| Program and Application ID that FB | |
| belongs to. Used in a system having a | |
| big application and many FB to | |
| provide categorization of the FB | |
| The company that constructed the FB | |
| The creation date of the FB | |
| FB version number | |
| FB validity indicator | |
| Date and person or entity that | |
| validated | |
| Date or person or entity that | |
| invalidated. | |
| Database to be hit by FB, allows | FB can access multiple databases |
| multiple databases to be hit from the | through a URL thus facilitating |
| system to provide a system | system integration of many |
| integration function. | applications that have been in |
| | different systems in the past |

Additionally, Function Buttons, FB 900, in addition to folders, comprise the tree view, as described in the aforementioned discussion of GUI 302. FB 900 always belong to a folder 640 and correspond to basic functionality entities of the system. FB 900 usually represent the whole or part of either simple or more complex business processes, depending on the scope of the application to be performed. FB 900 can open either a view form in the main working area or open a specified URL.

FB 900 and AB 800 have a plurality of supplementary quanta of information known as Processing Options 930. Processing Options 930 comprise a set of external, user-defined parameters, which are used to configure almost all features of Function Buttons 900 and Action Buttons 800. Additionally, Processing Options, PO 930, allow both Function Buttons 900 and Action Buttons 800 to be customized and copied with feature changes, i.e., the almost identical FB 900 or AB 800 demonstrate feature characteristics of polymorphism with respect to the original FB 900 or AB 800. The polymorphism, or feature change, wherein the FB 900 or AB 800 which has been modified by an associated PO 930 to perform a similar function but have minor differences on predetermined parameters, is useful to configure custom features such as, in the case of FB PO 930, View Form colors, static and dynamic filters, style, and the like. Similarly, customizations on an Info Form, such as predefined values, data protection, Foreign Key Forms, and the like are provided by the polymorphism feature of the present invention. Each AB 800 and each FB 900 can contain multiple PO 930 which are in turn exclusively associated with the AB 800 or FB. The number of PO 930 for each type of FB 900 or AB 800 is not necessarily constant, nor pre-defined. A system administrative environment is provided for activation of PO 930, FB 900 and AB 800.

Processing options are preferably divided in groups of data including, but not limited to, FB 900 PO 930, FB Browser Grid Fields PO 940, and FB edit fields PO 950.

Function Buttons 900 interact with each other via a master detail relationship, and via a many to many relationship. In a Master Detail relationship, while using the universal service, the present invention provides the capability to navigate from a first function button, to a second function button, so long as the relation between the first and the second are described in a Master Detail relationship table. The Master Detail relationship describes the fields from each Function Button that must be associated. In order to associate a function button to another, the function buttons must have at least one common value in any of the fields specified in a master detail association table.

Additionally, in the Many To Many relationship, given information associated with an FB1, and by a procedure of selecting N records of an FB2, N records of an FB3 may be created containing the data from the FBI and FB2. The relations between the FBI and FB2 and the data of the FB3 are described in a many to many relationship association table.

FB PO 930 also have additional data to permit a reverse interpretation. The additional data are shown in TABLE 4.

TABLE 4
Data Required for Reverse Interpretation

| | |
|---|---|
| VIEW that FB can call | |
| Type of FB in relation with | Types include: Single FB having no |
| Master Detail relationship | relation with other tables or views; |
| | many to many FB having a M2M |
| | relation with a table; Master Detail FB, |
| | wherein a detailed table is specified; |
| | Parallel Detail FB, (PD FB), wherein |
| | the PD FB is permitted to only look to |
| | a number of other parallel FB thus |
| | allowing N-level digging of data and |
| | describing a list of Parallel Details FB |
| Order BY string within which | |
| FB data will appear | |
| For a calling FB, required data | |
| will be fetched by the FB or | |
| optionally a wait state initiated | |
| to wait for a manual fetch | |
| FB with paging indicates how | |
| many pages are to appear and | |
| how many rows are allocated | |
| per page | |
| If FB requires a data export | |
| function, this data specifies how | |
| to export and a format for the | |
| report | |
| Data type that browser is | |
| permitted to open | |
| Edit old records and insert new | |
| records permissions | |
| Elements specified to appear in a | Elements include: filter bar; QBE bar; |
| View Form on the data grid | grouping bar; sorting bar; SUM, |
| | COUNT, AVERAGE, MIN, MAX bar; |
| | paging system; and, navigator |
| Events associated with a FB to | Events comprise: Before Edit (list of |
| allow Business Logic | software procedures to call); After |
| implementation where additional | Edit (list of software procedures to |
| software code is required | call); Before Add (list of software |
| | procedures to call); Before Delete (list |
| | of software procedures to call); After |
| | Delete (list of software procedures to |
| | call); Before View (list of software |
| | procedures to call); After View (list of |
| | software procedures to call) |

As shown above in TABLE 4, events associated with a FB 900 allow implementation of Business logic. The events are provided by the present invention to allow software code elements to be added to the system in cases that are not possible to be coded within the data. For example, in a case where it is desired to have a payment update account receivables of a customer with a paid amount, FB 900 would trigger auxiliary software code. Moreover, FB 900 will pass required data to the software that must be called, and receive status of the operation. As shown in TABLE 4, each event has a list of software that can be specified for calling on that event. In terms of object-oriented technology, the auxiliary software belongs to the class of Action Buttons 800.

The present invention provides for a record to be created in a table FB_BROWSER_GRID_PO for each field of a Logical Entity contained in an FB view. The FB_BROWSER_GRID_PO record has the capability to regulate how each field of the Logical Entity will be presented and behave during the execution of each FB 900. The FB_BROWSER_GRID_PO record includes the following information as shown in TABLE 5 below.

TABLE 5-1
FB_BROWSER_GRID_PO RECORD INFORMATION

| | |
|---|---|
| Whether the field is viewable during | |
| the execution of the FB | |
| Whether the field is editable | |
| Field width in the data grid | |
| Associated FB ID | |
| SQL filter to apply for this field | |
| during execution of the FB | |
| Field Name (from the Table) | |
| Name that field is to be called in this | |
| FB | |
| Grid Color for this field, and grid | |
| attributes, such as BOLD, ITALIC, | |
| UNDERLINED, and the like | |
| Whether the field is a member name | User's may be filtered out as each |
| and whether a filter for members | User belongs to a member group |
| should be applied | |
| If field is type USER then apply the | |
| filter of user | |
| If field type is COMPANY then | |
| apply company filter to the user | |
| Whether the field is printable | (during report or export to other |
| | applications) |
| Format field of field | Each field has an associated format |
| | field |
| Whether the field is data security and | |
| whether a data security control | |
| should be applied | |
| Whether field column width is | |
| changeable by user during execution | |
| Value delimiters of the field during | |
| editing | |
| Whether the field must be completed | |
| during editing, i.e., whether the field | |
| is obligatory | |
| For numeric fields, if the database | |
| entry will have a reverse sign | |
| List of events to apply after editing | |
| this field | |

Additional table FB_Edit_Form_Fields_PO inherits the same data as the list of events to apply, as described in TABLE 5. Included in FB_Edit_Form_Fields_PO are data relating to the appearance of the field in the edit form, such as, but not limited to group name, (allows fields to be grouped under the same tab in the edit form), label length, edit field length, an X coordinate and a Y coordinate, designating the position of the field in the form, and an edit series number. Moreover, a M2M relation table is constructed, defining the list of AB associated with each FB and visible during function execution.

Folders 640 and menus 650 are provided in a structured form at the top of the data hierarchy including all of the Function Buttons. For example, Folders 640 represents an entity containing Function Buttons 900, with a many to many, i.e., M2M, relationship, or other Folders 640. Folders 640 are then contained in a Menu 650. Menus 650 contain Folders 640 and Function Buttons 900. The Menu structure includes Menu ID, and Menu Description. The Folder structure includes Folder ID, Menu in which the Folder 640 belongs, Folder 640 in which the Folder 640 belongs, and a M2M relation list having the Function Buttons 900 that belong to the Folder 640.

Additionally, a user model, UM 700, is a hierarchical model provided to associate users with generated applications. The USER MODEL hierarchy from highest to lowest comprises: Organizations 710 which are groups of companies 720; then companies 720; then members of companies 730, of which members 730 may also include business units, branches, departments, and the like; then users 740, which are the most elementary actor on the system. Each user may be associated with a specific menu 650 and with a specific member 730. Additionally, each user 740 belongs to a member 730 and has its own data, information regarding validity of user entries for that user 740, a user login name, an encrypted password, user font, user font size, and application title. Associated with each user are Security Levels including FB Security range, AB Security Range, and Data Security range. Security levels of the present invention allow separation of Menus between Users 740, and permit different access of different Users 740 depending on the Menu Security ranges, Action Button Security ranges, Data Security ranges, Member, Company, and User filtering of the data.

Additionally, Global security levels 400 are included to provide control of collaboration over the system in a dynamic and flexible way. In an environment where different users 740 access the system with different roles and communicate over common data structures and workflows, global security offers a means for securing the environment. Global Security along with the User Security comprises a multi-level security framework that differentiates the present invention from other conventional applications and improves significantly the system efficiency, since it is easy to maintain.

The Global Security is based on a series of sequential levels. As shown in FIG. 4, there exists a many to one relationship between users 740 and system members 730; a many to one relationship between system members 730 and company 720; and a many to one relationship between company and organization 710.

However, global security operates only on the company system member 730, and user 740 entities. Note that User 740 is defined as being the end-user, who gains access on the system using unique User name and Password. As a result every user 740 that logs in the system carries the information about the User 740, the System Member 730 and the affiliated Company 720. This information is stored in a session, as soon as the user 740 is logged in the system.

On the application data level, the capability is provided to always insert appropriate columns that represent the User 740, the Company 720, the System Member 730 or any combination of them. These columns may refer either to the Company 720, the Member 730 or the User 740 that inserts and possesses the data or the Company 720, Member 730 or User 740 that can access the data.

Additionally, the system supports a set of Processing Options 930 for the setup of global controls. These Processing Options 930 can act as dynamic filters on the application data depending on the current user information. According to a global security setup, the current user who logs in the system may be able to access only data having the same User 740, and Member 730 of Company identification.

The dynamic filters based on the Global Security Levels 400 are managed on the View Processing Option page, since they refer to the View Form. In addition, the information about the User 740, the Member 730 and the Company 720 that every user carries when logging in the system may be provided as predefined values, when adding new records on an application. This serves as a justification of the data regarding its origin and may be provided for filtering purposes. This dynamic filter is defined on the Processing Options of IO.

The present invention provides for the Universal Service 1000 application in communication with the Application Model 600 and the User Model 700 to permit the reading of all data where the application and the user related information are stored. The Universal Service 1000 application creates a user environment that provides for execution of the application. Operation of the system may be initiated interactively or automatically from another system, thus enabling the User 740 to be a person, a machine, and the like. The Universal Service 1000 is comprised of an engine that continuously functions, providing, among other things, a plurality of logical entity views in response and in service to users. Initialization of the Universal Service engine comprises loading the Data Dictionary and the Glossary Tables for the translations, and accepting login calls as a URL.

Furthermore, Universal Services 1000, using an Internet Browser, such as Internet Explorer®, provides a web page with the URL of an application to be called for login purposes. Also provided are user name and user password fields to be filled in by a user. Universal Services, US 1000, then validates the user and password, and subsequently performs the US 1000 algorithm.

The US 1000 algorithm opens a web page comprised of at least 1 section, preferably 4 sections. The first section is a menu area providing a view of all folders 640 and menus 910. The second section provides a Header Area displaying the name of the company using the system, copyright notices, language manipulation options, and a logout button. The third section provides the data grid area for the presentation of all data. The data grid area is subdivided in sub-sections for displaying the system Action Button area, the Application Action Button area, the QBE area, and the data grid. In addition to the data grid section is a 4th section, the message area, which is user configurable and may accommodate a plurality of forms.

The plurality of forms handles all of the application and system data. As discussed above, the forms are loaded in the Main Working Area, except for a login form. The plurality of forms comprises at least six basic types including, but not limited to the Login Form, the View Form, the Info Form, the Many To Many Form, the Foreign Key Form, and the Account Management Form.

Within the Login Form, the present invention provides for at least a User Name Box in which the user inserts a username, a User Password Box in which the user inserts their password, a Language Drop-Down List in which the user has the capability to override a default language and select a language of the application environment, a second Language Drop-Down List in which the user can dynamically select a language of the data content, and a Database Selection Drop-Down List in which the user can select a target database to be used by the application for data fetching.

Additional Login Form functionality includes user authentication. If the user authentication is not successful, the system may block the unsuccessful user account after a predetermined number of unsuccessful attempts to login. If the user login is successful, then the GUI environment 302, as discussed supra, is presented.

The View Form is common in that it is the first one appearing when the user opens a Function Button 900. The View Form is provided to display data fetched from the database in the data grid, wherein the data grid covers a largest area of the View Form. The data grid allows a set of user operations on its contents, the operation types being dependent on whether the grid is standard or advanced. Database Action Buttons 810 that may appear on the View Form include FIND, ADD, DELETE CLOSE, REPORT, HELP, EXPORT, COPYRECORD, VIEW INFO, and QBE. Business Action Buttons 820 that may appear on a vertical toolbar on the left side of the data grid include business process related actions such as STATUS ADVANCE, or SPLIT. Additional View Form objects are listed in Tables 2 and 4.

The Info Form provides a means for the user to edit data of a selected line of the data grid or to add a new line. The Info Form opens when the user selects a line from the View Form and performs EDIT, or selects the ADD Action Button from the View Form of a Function Button 900. The Info Form comprises a horizontal toolbox of Database Action Buttons 810 on the top, and a series of edit boxes with associated labels. Supported Action Buttons include OK, CANCEL, APPLY, ADD, and DELETE. Info Form also includes edit boxes with corresponding labels representing data fields and columns of the respective View Form. Controls supported by the edit boxes include: Textbox which accepts alphanumeric data; Numeric, which accepts numbers only; Arithmetic, which accepts real numbers; Foreign Key, accepts a lookup on another Function Button where the user selects a row and the selected row's key appears in the textbox of the Foreign Key after the selection; Date Data, includes dates selected from a Calendar control; UDC value, provides a drop down list from which the user can select a predefined value; Boolean, provides a “Yes/No” control;, URL, provides a control for the assignment of one or more URLs to a record in which the user can add, edit, delete and open a URL;, XML, provides a control that displays long text having XML format;, Attachment provides a control for the attachment of files on a particular data row, in which the control saves the attachment's path as a string and loads the path locally when required, and the user can add, edit, delete and open an attachment from the attachment control. Additionally, the Info Form is capable of displaying a simple browser presentation option as well as a parallel detail browser presentation option. The simple browser comprises one tab, which includes Info Form features as discussed above. The parallel detail browser has the capability of displaying and detailing different views in addition to the main Info Form.

The Many-To-Many Form is displayed as a second tab to the Info Form, but only in cases in which data displayed comprises many-to-many entity relationships as predetermined and set within the database being accessed.

The Many-To-Many Form comprises an Action Button toolbar on the top of the form, and a control in the middle of the Form having two List boxes and two Arrow Buttons. The left side List box may display a set of entities associated with a current line of data, while the right side List box may comprise a set of available entities the user can select from. Only a single AB 810, APPLY (MANY-TO-MANY), may appear on a M2M form.

The Foreign key Form is similar to the View Form, but is designed to provide for selection of records from a Foreign Key Control. This requires the overhead Action Button toolbar to have three buttons by default, FIND, SELECT and CANCEL. Foreign Key Forms open exclusively through Foreign Key Controls and allow the user to select a single record among a list of available records.

The Account Management Form, unlike the other forms, is not opened through Function Buttons, but rather is loaded from a link labeled “My Account” which is found in the Banner area of the GUI 302. The Account Management Form provides general information about an active User Account, such as the User Name, Last Login Name, Account and Password Valid period. Password expiration times are checked, and as appropriate, the user is prompted and offered several password change options.

As shown in GUI FIG. 3A, US 1000 has the capability of displaying a page of one user after all input data have been interpreted. As shown in FIG. 3A, GUI 302 displays a M2M relation creation. Additionally, a structured edit form is provided.

Utilizing menus in the GUI 302, US 1000 has the capability to read the folders 640 of menu 650 and FB 900 associated with each Folder 640. Subsequently, the folders 640 and FB 900 will be presented in a designated part of the Menu Area web page with the fonts and size designated by the User 740. As discussed, supra, not all FB 900 and Folders 640 appear to a User 740. Only those FB 900 and Folders 640 that have a security level matching each Folder 640 and FB 900 related with the Menu Security of the User 740 are provided for display.

Selecting a FB 900 initiates a process of work that opens the data grid and causes all System Action Buttons, SAB 810, and Application Action Buttons, AAB 820, to appear, defining most of the User security parameters. Subsequently the View related with the selected FB 900 is read and all fields that have been marked visible for the user appear. Each displayed field will provide the specified color, width, and designation, i.e., whether the field is normal, bold, underline, italic, and the like. If the FB 900 is set, Autofetch will apply the query, applying a SQL Filter for each field.

Query results are provided in a Data Grid containing the data of the view as personalized for this FB. At this time all necessary operations for this FB 900 can be performed through the related actions. If the FB 900 contains Parallel Details, they will appear in tabs 363 with the name of each parallel detail (as shown in FIG. 3C).

Selecting one of the Parallel Detail tabs calls the FB2 900 of the detail, repeating the Fetch Cycle for the designated FB2 900. Returning from the FB2 900 will return to the original FB 900. DYNAMIC FILTERS are provided over all FB 900. Additionally, the US 1000 will recognize all parameters that have been specified in the data model. Records can be added or edited using the AB ADD or EDIT or the associated keyboard keys. In the EDIT or ADD form, a new page will open with all fields that are viewable in gray and the editable fields with white, as specified by the PO 950 of the FB 900 open for edit. In this way only the allowed fields will be viewable.

Additionally, the US 1000 places all fields, using data and associated column widths as specified in the PO 950. Format and allowable values are checked for each field. Whether the field is obligatory is also checked. Any entry errors are flagged and displayed. Each record associated with each field will be processed according to execution of events as described in the PO 950 of the FB 900 or the individual field.

Additionally, Universal Service, US 1000, provides a Universal Web Service, UWS 1010, running on a web server, to allow non-interactive, automatic system processing. The present invention provides web services having the capability to access Function Buttons 900 and their associated functionality. A URL command is sent through the Internet and, responsive to the URL command, US 1000 replies appropriately, sending data through an XML procedure. Exemplary web services and their description are shown in Table 5-2

TABLE 5-2
WEB SERVICES AND DESCRIPTION

| Name of Web Service | Description |
|---|---|
| getFB | Gets the data of the corresponding function button |
| Insert | Inserts data |
| Insert_Update | Inserts or updates data |
| Delete | Deletes data |
| Status Advance | Status advance to some data |
| Split | Split some data |
| ExternalAB | External call of an Action Button |

Clients, i.e., programs, call up the UWS 1010 website and declare information containing User, Member, Password, Web address, Operation Number, Extra Filters, Action Number (Action Button 800 to be energized), Info List to Add/Edit, Language, Company Data Content, and Fields to add. If the action is SHOW, the UWS 1010 sends the data grid. For any Action, the system applies the specified actions and sends a report of the action back to the user. If the button to be energized is ADD or EDIT record, the system reads the fields to ADD or EDIT and adds a record or edits an existing record. This remote UWS 1010 processing observes the same security limitations as applied to a non-remote user, in that members and users are limited to their own views as specified by the security limitations. All applications are accessible through UWS 1010 because all Universal Service 1000 functions are available through UWS 1010. Therefore, the present invention provides for easy facilitation of communication with external software systems.

A language translation capability that translates any string according to an Application Translation, a Data Content Translation, or a Company related Data Translation is provided.

The Application translation function of the present invention provides the capability to translate to a plurality of other languages, all fields of the Application related strings including name of field, name of folder, menu, action button, system message, and the like.

The Data Content translation function of the present invention provides the capability to translate to a plurality of other languages, data that has been designated in the Data Dictionary table of fields for content translation. An example of data that is designated in the Data Dictionary table of fields for content translation is a UDC table with mode of payments in data, i.e., non-numeric form.

The present invention provides for the aforementioned translations by performing the steps of including an action button 800 that initially creates a master of the strings designated for language translations and a master of the strings designated for company translations.

The language translation and company translation masters are created by searching for all the translation designated strings among the data related to applications. Similarly, records related to all fields marked for content translation are saved. At least two Master tables are created, one for the language, and another for company specific strings in a default language.

An AB 800 creates an empty table associated with the Master for each field designated for translation to a specified language. Empty string names, which were created by the AB, are then filled with an output from a language translator. Similarly, an AB 800 creates an empty table associated with the Master for each field associated with a company. The empty table is then completed with the proper names, i.e., cross-references, by a person or other user knowledgeable in company terminology. The strings, i.e., fields designated for translation are dynamically changed during execution of Universal Services, US 1000. While default data depends on the language of the user and the company the user is related to, the language may still be dynamically changed according to the translation AB 810. Reports, exports and Universal Web Services, UWS 1010, are similarly capable of being translated.

To allow for the fact that the system is open and that any user may, with appropriate security levels, add new applications, user assistance in the form of Help records are attached to folders 640, function buttons, FB 900, and action buttons, AB 800. A URL link field is associated with each of the entities, i.e., the folders 640, the FB 900, and the AB 800. During execution from the US 1000 page, help may be accessed by a pointing device, e.g., a right click button of a mouse. FB, i.e., function button 900 access is done by pressing the relevant HELP Action Button 800. A help translation to other languages is accomplished by adding a language suffix to the default URL.

The present invention includes a Universal Workflow Engine 1020 which accepts input from activity rules and provides the capability for any operation in the system to be accomplished following a workflow. Workflow rules generated by the Workflow Engine 1020 are based on the activity rules related to and passed by a Logical entity during a life cycle of the Logical entity. For example, a customer Order must first be a proposal. Next, a confirmed customer Order must have a defined price and delivery time, as well as shipment approval, e.g., in addition to a defined price and delivery time, the confirmed order must be designated to be shipped e.t.a.

Workflow rules of the present invention provide for each logical entity having a predefined data set permitting the execution of the workflow. The predefined data are document type, which specifies from an open list the name of the logical entity, line type, which further diversifies a logical entity, separating at least two records of the same document type, (for example, in a Production Outsource Relations it is necessary to send Materials. However, the return from the production outsourcing requires that the received Materials be different than the Materials sent.), current status which is a numeric field showing the actual status of the Logical Entity, next status, which is a naturally occurring following state of the Logical Entity, and last status updated date, which is the date and time of the last status change.

The present invention provides for the creation of an Activity Rule Table indicating for all document types and for all line types the possible states of the associated logical entities, and for any given status, the next naturally occurring status, as well as alternate statuses. A generic status advance Action Button 820 has the capability to perform an advance of status. The generic status advance AB 820 can be cloned so that various scenarios associated with a specific FB 900 may be provided. The Status Advance can be applied in any table of the system that contains information about Document Type, Line Type, Current Status, Next Status, and Status Advance Date. Additionally, the generic status advance AB 820 can recognize the activity rules of a specific logical entity and perform a next status operation, a reverse status operation, or force a status advance operation. Moreover, a multi status advance button is provided to change the status of one or more lines taking into account the activity rules and Processing Options of the Status Advance action button. The following table illustrates the status advance processing options provided by the present invention.

TABLE 6

| Processing Options | Values | Setup |
|---|---|---|
| FROM STATUS | NUM | Starting record Next |
| | | Statuses within which |
| | | the action will be |
| | | allowed |
| TO STATUS | NUM | Ending record Next |
| | | Statuses within which |
| | | the action will be |
| | | allowed |
| DIRECTION | F/B | Defines the direction to |
| | | which the algorithm is |
| | | going to be performed |
| | | and can be Forward (F) |
| | | or Backward (B). F |
| | | makes the Next Status |
| | | current and retrieves |
| | | new Next Status from |
| | | the Activity Rules. B |
| | | makes the Current |
| | | Status next and |
| | | retrieves the new |
| | | Current Status from the |
| | | Activity Rules. |
| OVERRIDE NEXT STATUS | Y/N | Defines whether the |
| | | algorithm will get the |
| | | default Next Status or |
| | | one of the Alternative |
| | | Nest Statuses of the |
| | | Activity Rules |
| NEW NEXT STATUS | NUM | Field that is inserted |
| | | only if the “OVERRIDE |
| | | NEXT STATUS” is “Y” |
| | | This field refers to the |
| | | Alternative Next Status |
| | | picked instead of the |
| | | default one during the |
| | | status advance |
| | | algorithm. Field is |
| | | defined in the Activity |
| | | Rules. |

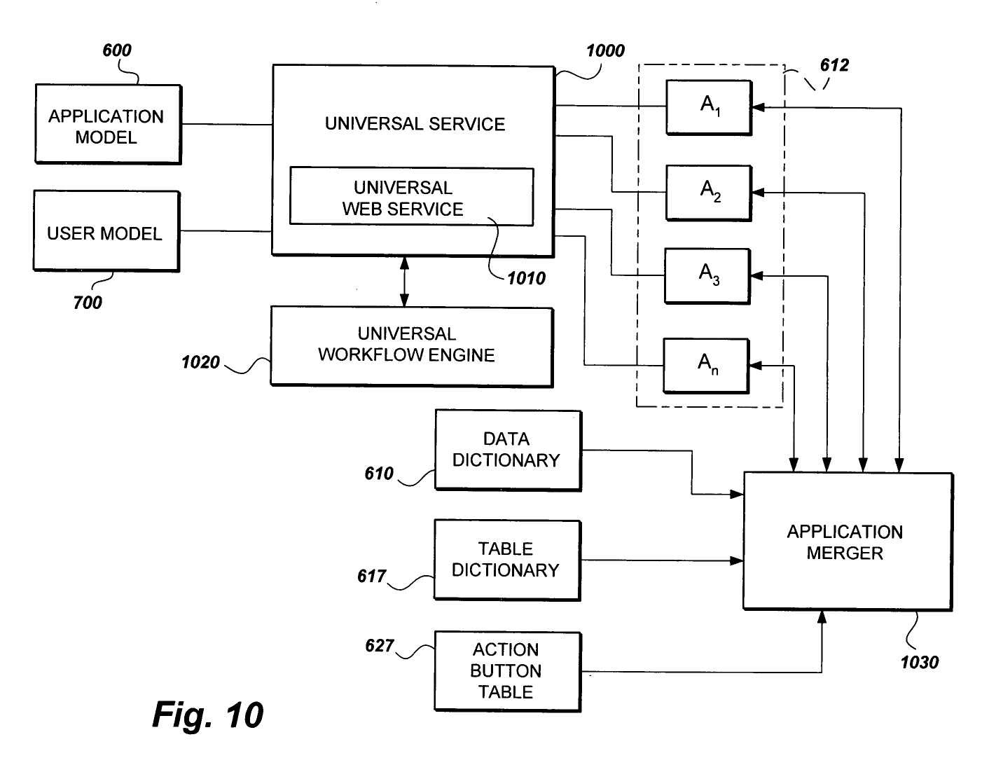

As shown in FIG. 10, Application merging is provided by an Application Merger 1030 of the present invention. The Application Merger 1030 advantageously provides any user with the capability to write an application 612 that can be merged with other applications 612. In addition to the application merging capability, because the present invention dynamically operates on data, not software code, applications can be added or changed while the whole system is still functioning. Additionally, new rules or models created by application merging 1030, application addition, or application modification are immediately available to all applications requiring the use of the new rules or models.

The application merging capability of the present invention is possible because the majority of applications are based on data, and not on code. The business logic that relies on software code is in independent modules, thus allowing for an application merging method that relies solely on and accepting input from the Data Dictionary including the Table and Field Dictionaries in the form of data, Inter-table Relations as described in the Table Dictionary, Action Buttons that are stored in the Action Button Table, the Business Logic as coded in software existing in discrete modules, i.e., a known path to a dynamically linked library, (.dll), Function Buttons that are in the Function Data Table together with the PO of the FB which are in data form, and Folders and Menus that are in data form.

Each user 740 who is performing a system development function numbers the data that the user 740 is working on differently from any other system developer's numbering scheme such that there will be no conflict during the application merging function. In the event of conflicting numbering, an algorithm in a database procedure is used to eliminate the conflict, e.g., line numbers may be multiplied by a constant to eliminate the conflict.

The automatic procedure of merging applications includes copying the Data Dictionary Tables, Inter-tables, Views and Fields, copying Action Buttons and PO of the Action Buttons, copying Function Buttons and PO of the Function Buttons, copying Folders and Menus, copying the software coded modules for business logic in the designated path, and then associating any part of the application to the users.

It is to be understood that the present invention is not limited to the embodiment described above, but encompasses any and all embodiments within the scope of the following claims.

I claims:

1. An enterprise system development method performed by a machine executing a program of instructions tangibly embodied in a program storage device readable by the machine, the method comprising the steps of:
constructing a plurality of business entities;
specifying a plurality of functions to be related to the plurality of business entities;
defining business requirements of the enterprise by establishing relationships among the plurality of business entities;
interpreting the relationships among the plurality of business entities;
applying a plurality of actions to the plurality of functions responsive to the interpreting of the relationships among the plurality of business entities, thereby creating a plurality of logical entities;
specifying a plurality of activity rules to be related to the plurality of logical entities; and
executing the plurality of functions in a workflow determined by the plurality of activity rules, wherein the business requirements are applied to the enterprise.

2. The enterprise system development method as claimed in claim 1, wherein the step of interpreting of the relationships among the plurality of business entities further comprises presenting, in a graphical user interface (GUI), tables and views of the relationships demonstrating a results of the interpreting to a user.

3. The enterprise system development method as claimed in claim 1, wherein the step of executing the plurality of functions in a workflow further comprises the step of executing a plurality of applications that can be stored in a database for application re-use and application merging.

4. The enterprise system development method as claimed in claim 3, wherein the step of executing a plurality of applications further comprises the step of executing User Defined Code.

5. The enterprise system development method as claimed in claim 1, wherein a menu area of a GUI displays a tree view having a first plurality of nodes comprising folders, and distributed within the folders, a second plurality of nodes comprising function buttons.

6. The enterprise system development method as claimed in claim 5, wherein the step of constructing the plurality of business entities further comprises the step of associating the business entities hierarchically into the folders.

7. The enterprise system development method as claimed in claim 5, wherein the step of specifying the plurality of functions to be related to the plurality of business entities further comprises the step of assigning the plurality of functions to the function buttons.

8. The enterprise system development method as claimed in claim 1, further comprising the step of providing data, structure, and rules in a relational database having the capability to codify application functionality, wherein business logic is implemented based on requirements input by the user.

9. The enterprise system development method as claimed in claim 8, wherein the step of applying the plurality of actions to the plurality of functions comprises the capability to modify, delete, or add business requirements according to interaction of the user with the relational database.

10. The enterprise system development method as claimed in claim 9, wherein the step of applying the plurality of actions further comprises the step of the user selectively activating action buttons displayed in a GUI, each of the action buttons having been assigned to perform a specific action of the plurality of actions.

11. The enterprise system development method as claimed in claim 10, wherein the input by the user comprises user communication to the system via the World Wide Web.

12. The method for enterprise system development as claimed in claim 11, wherein a plurality of users is permitted to instantiate different versions of a same function button, thereby facilitating user collaboration within the method.

13. The method for enterprise system development as claimed in claim 12, further comprising the step of providing a multi-level security framework to control collaboration in a dynamic and flexible manner.

14. The method for enterprise system development as claimed in claim 13, further comprising the steps of:
providing global security levels hierarchically among company, system and user entities; and
providing user security levels to control action button access and data access of each user.

15. The enterprise system development method as claimed in claim 10, further comprising the step of providing processing options for the purpose of configuring customization features of the function buttons and the action buttons.

16. The enterprise system development method as claimed in claim 1, further comprising the step of allowing the user to select a language of an environment of the system.

17. An enterprise system development system, comprising:
an application model for providing data codification of required business applications;
a user model for associating users with generated applications;
a universal service in communication with the application model and the user model to permit the reading of all application and user related information for the purpose of creating a user environment that provides for execution of the applications, the universal service having a universal workflow engine accepting input from activity rules related to and passed by a logical entity, the universal workflow engine generating workflow rules for any system operation requiring a workflow;
a universal web service in communication with the universal service, the universal web service permitting non-interactive, automatic system processing responsive to clients over the Internet; and,
an application merger accepting inputs from a data dictionary, a table dictionary, and an action button table, the application merger having the capability to merge a user written application with other applications.

18. The enterprise system development system as claimed in claim 17, further comprising global security levels to provide access security among user, member, and company entities of the system.

19. The enterprise system development system as claimed in claim 18, wherein the access security includes a global security setup limiting a user to access only data having a same user and member of company identification.
